(19) United States
(12) Patent Application Publication
(10) Pub. No.: US 2024/0177921 A1
(43) Pub. Date: May 30, 2024

(54) COIL COMPONENT

(71) Applicant: SAMSUNG ELECTRO-MECHANICS CO., LTD., Suwon-si (KR)

(72) Inventors: Woo Jin Lee, Suwon-si (KR); Dong Hwan Lee, Suwon-si (KR); In Young Kang, Suwon-si (KR); Boum Seock Kim, Suwon-si (KR)

(73) Assignee: SAMSUNG ELECTRO-MECHANICS CO., LTD., Suwon-si (KR)

(21) Appl. No.: 18/514,412

(22) Filed: Nov. 20, 2023

(30) Foreign Application Priority Data
Nov. 24, 2022 (KR) 10-2022-0159440
Apr. 6, 2023 (KR) 10-2023-0045543

(51) Int. Cl. H01F 27/28; H01F 27/29; H01F 27/32

(52) U.S. Cl. CPC H01F 27/2852; H01F 27/29; H01F 27/323

(57) ABSTRACT

A coil component includes a body, a support member disposed within the body, a first coil disposed on one surface of the support member, a second coil disposed on the other surface of the support member, a first pad connected to one end of the first coil, a second pad connected to one end of the second coil, a plurality of conductive vias connecting the first pad and the second pad, a first external electrode disposed on the body and connected to the other end of the first coil, and a second external electrode disposed on the body and connected to the other end of the second coil.

### CROSS-REFERENCE TO RELATED APPLICATION (S)

This application claims the benefit of priority to Korean Patent Application No. 10-2023-0045543 filed on Apr. 6, 2023 and Korean Patent Application No. 10-2022-0159440 filed on Nov. 24, 2022 in the Korean Intellectual Property Office, the disclosures of which are incorporated herein by reference in their entirety.

### TECHNICAL FIELD

The present disclosure relates to a coil component.

### BACKGROUND

Along with the miniaturization and thinning of electronic devices such as digital TVs, mobile phones, laptops, etc., coil parts applied to such electronic devices are also required to be miniaturized and thin. To meet these demands, research and development of various types of winding type or thin film type coil parts are being actively conducted.

A major issue due to the miniaturization and thinning of coil parts is to implement characteristics equivalent to those of the existing coil parts despite such miniaturization and thinning.

A thin-film power inductor includes conductive vias for electrical connections between coil layers. In implementing a thin-film power inductor for high current, if the thickness of the substrate cannot be further increased to significantly increase design characteristics, the diameter of the via hole should be increased. However, when the diameter of the via hole is increased, a so-called seam void defect may occur in which a region in which the plating material is not filled is generated inside of the conductive via.

### SUMMARY

An aspect of the present disclosure is to implement a coil component having excellent characteristics by reducing resistance of a via connection without defects.

According to an aspect of the present disclosure, a novel structure of a coil component is proposed through an example. The coil component includes a body, a support member disposed within the body, a first coil disposed on one surface of the support member, a second coil disposed on the other surface of the support member, a first pad connected to one end of the first coil, a second pad connected to one end of the second coil, a plurality of conductive vias connecting the first pad and the second pad, a first external electrode disposed on the body and connected to the other end of the first coil, and a second external electrode disposed on the body and connected to the other end of the second coil.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 perspective view schematically is a illustrating a coil component according to a first embodiment;

FIG. 2A and FIG. 2B are an exploded view illustrating some components of FIG. 1, and an assembly view illustrating connection relationships between components;

FIG. 3 is a view illustrating a cross-section taken along line I-I′ of FIG. 1; FIG. 4 is a plan view of the coil component of FIG. 1 viewed from above;

FIGS. 5 to 9 are plan views of coil components viewed from above, as modified examples of the first embodiment ;

FIG. 10 is a perspective view schematically illustrating a coil component according to a second embodiment;

FIG. 11 is an exploded view illustrating some components of FIG. 10, and is an assembly view illustrating connection relationships between components;

FIG. 12 is a plan view of the coil component of FIG. 10, viewed from the top;

FIGS. 13 and 14 are plan views of a coil component viewed from above, as a modified example of the second embodimen;

FIG. 15 is a perspective view schematically illustrating a coil component according to a third embodiment;

FIG. 16 is an exploded view illustrating some components of FIG. 15, and is an assembly view illustrating connection relationships between components;

FIG. 17 is a plan view of the coil component of FIG. 16, viewed from above; and

FIG. 18 is a plan view of a coil component viewed from above, as a modified example of the third embodiment.

### DETAILED DESCRIPTION

Hereinafter, embodiments will be described with reference to detailed embodiments and accompanying drawings. However, the embodiments of the present disclosure may be modified in many different forms, and the scope of the present disclosure is not limited to the embodiments described below. In addition, the embodiments of the present disclosure are provided to more completely describe the present disclosure to those skilled in the art. Therefore, the shape and size of elements in the drawings may be exaggerated for clearer explanation, and elements indicated by the same reference numerals in the drawings are the same elements.

Various types of electronic components are used in electronic devices, and among these electronic components, various types of coil components may be appropriately used for removing noise. For example, in electronic devices, coil components may be used as power inductors, HF inductors, general beads, GHz beads, common mode filters, etc.

### First Embodiment

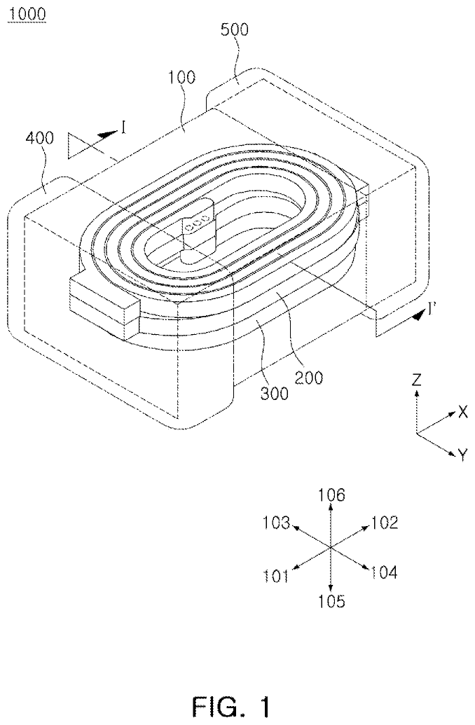

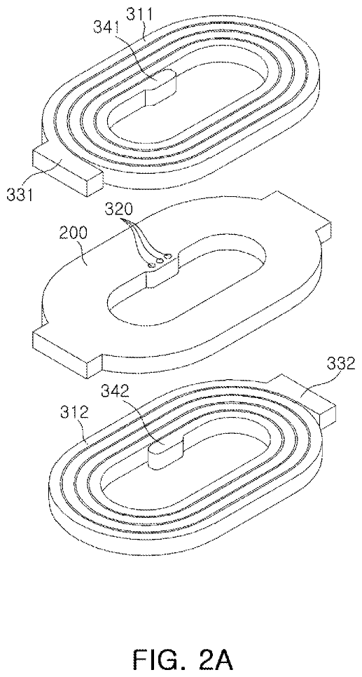

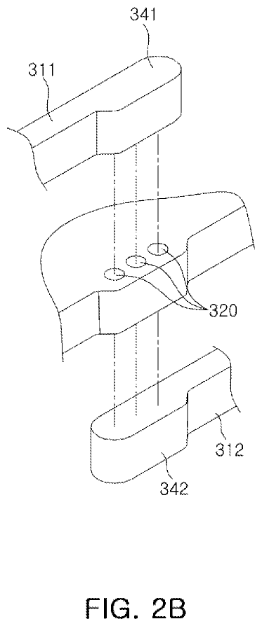

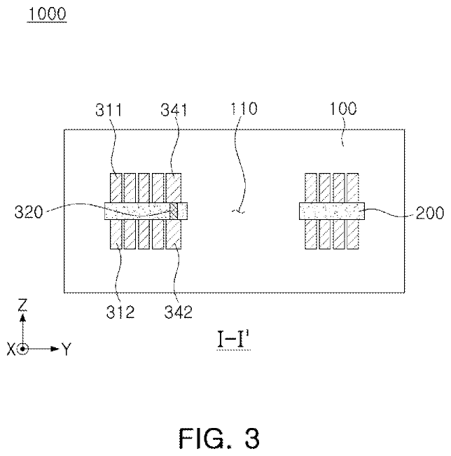

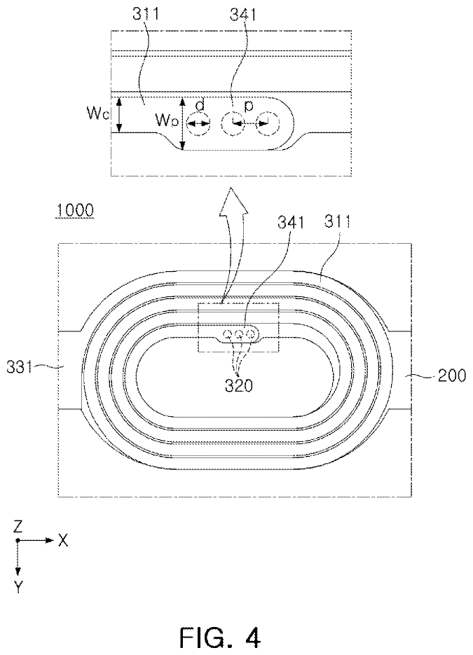

FIG. 1 is a perspective view schematically illustrating a coil component according to a first embodiment. FIG. 2 is an exploded view illustrating some components of FIG. 1, and is an assembly view illustrating a connection relationship between the components. FIG. 3 is a view illustrating a cross-section taken along line I-I′ of FIG. 1. FIG. 4 is a plan view of the coil component of FIG. 1, viewed from above.

Referring to FIGS. 1 to 4 together, a coil component 1000 according to the present embodiment includes a body 100, a support member 200, a first coil 311, a second coil 312, a first pad 341, a second pad 342, a plurality of conductive vias 320, a first external electrode 400, and a second external electrode 500. Hereinafter, the main elements constituting the coil component 1000 of the present embodiment will be described.

The body 100 forms the exterior of the coil component 1000, and the coils 311 and 312, the support member 200 and the like are disposed therein. As illustrated in the drawings, the body 100 may be formed in the shape of a hexahedron as a whole. The body 100 may include a first surface 101 and a second surface 102 opposing each other in a first direction (X-direction), a third surface 103 and a fourth surface 104 opposing each other in a second direction (Y-direction), and a fifth surface 105 and a sixth surface 106 opposing each other in a third direction (Z-direction). The body 100 may have one surface 106, the other surface 105 opposing the one surface in the third direction (Z-direction), and a plurality of side surfaces 101, 102, 103, and 104 connecting one surface and the other surface.

As an example, the body 100 may be formed such that the coil component 1000 according to the present embodiment in which the external electrodes 400 and 500 to be described later are formed has a length of 2.5 mm, a width of 2.0 mm and a thickness of 1.0 mm, or a length of 2.0 mm, a width of 1.2 mm and a thickness of 0.65 mm, or a length of 1.6 mm, a width of 0.8 mm and a thickness of 0.8 mm, or a length of 1.0 mm, a width of 0.5 mm and a thickness of 0.5 mm, or a length of 0.8 mm, a width of 0.4 mm and a thickness of 0.65 mm, but the present disclosure is not limited thereto. On the other hand, since the above-mentioned numerical values are merely design values that do not reflect process errors, or the like, it should be regarded that the range that may be recognized as a process error belongs to the scope of the present disclosure.

The length of the coil component 1000 described above in the first direction (X-direction) may refer to a maximum value among dimensions of the plurality of respective line segments that respectively connect the two outermost boundary lines facing each other in the first direction (X-direction) of the coil component 1000 illustrated in the cross-sectional image and are parallel to the first direction (X-direction), based on an optical microscope or scanning electron microscope (SEM) image of a cross-section of the coil component 1000 in the first direction (X-direction) -third direction (Z-direction) at the center of the coil component 1000 in the second direction (Y-direction).

Alternatively, the length of the above-described coil component 1000 in the first direction (X-direction) may refer to a minimum value among dimensions of the plurality of respective line segments that respectively connect the two outermost boundary lines facing each other in the first direction (X-direction) of the coil component 1000 illustrated in the cross-sectional image and are parallel to the first direction (X-direction). Alternatively, the length of the above-described coil component 1000 in the first direction (X-direction) may refer to at least three arithmetic average values among dimensions of the plurality of respective line segments that respectively connect the two outermost boundary lines facing each other in the first direction (X-direction) of the coil component 1000 illustrated in the cross-sectional image and are parallel to the first direction (X-direction). In this case, the plurality of line segments parallel to the first direction (X-direction) may be equally spaced from each other in the third direction (Z-direction), but the scope of the present disclosure is not limited thereto.

The length of the coil component 1000 described above, in the second direction (Y-direction), may refer to a maximum value among dimensions of the plurality of respective line segments that respectively connect two outermost boundary lines facing each other in the second direction (Y-direction) of the coil component 1000 illustrated in the cross-sectional image and are parallel to the second direction (Y-direction), based on an optical microscope or scanning electron microscope (SEM) image of a cross-section of the coil component 1000 in the first direction (X-direction)-second direction (Y-direction) at the center of the coil component 1000 in the third direction (Z-direction). Alternatively, this length may refer to a minimum value among dimensions of a plurality of respective line segments that respectively connect two outermost boundary lines facing each other in (Y-direction) of the coil component the second direction 1000 illustrated in the cross-sectional image and are parallel to the second direction (Y-direction). Alternatively, this length may refer to an arithmetic average value of at least three of dimensions of a plurality of respective line segments that respectively connect two outermost boundary lines facing each other in the second direction (Y-direction) of the coil component 1000 illustrated in the cross-sectional image and are parallel to the second direction (Y-direction). In this case, the plurality of line segments parallel to the second direction (Y-direction) may be equally spaced from each other in the first direction (X-direction), but the scope of the present disclosure is not limited thereto.

The length of the coil component 1000 in the third direction (Z-direction) described above may refer to a maximum value among the dimensions of the plurality of respective line segments that respectively connect the two outermost boundary lines facing each other in the third direction (Z-direction) of the coil component 1000 illustrated in the cross-sectional image and are parallel to the third direction (Z-direction), based on an optical microscope or scanning electron microscope (SEM) image of a cross-section of the coil component 1000 in the first direction (X-direction) -third direction (Z-direction) at the center of the coil component 1000 in the second direction (Y-direction). Alternatively, this length may refer to a minimum value among the dimensions of the plurality of respective line segments that respectively connect the two outermost boundary lines facing each other in the third direction (Z-direction) of the coil component 1000 illustrated in the cross-sectional image and are parallel to the direction (Z-direction). Alternatively, this length may refer to at least three arithmetic average values among the dimensions of the plurality of respective line segments that respectively connect the two outermost boundary lines facing each other in the third direction (Z-direction) of the coil component 1000 illustrated in the cross-sectional image and are parallel to the third direction (Z-direction). In this case, the plurality of line segments parallel to the third direction (Z-direction) may be equally spaced from each other in the first direction (X-direction), but the scope of the present disclosure is not limited thereto.

On the other hand, each of the lengths of the coil component 1000 in the first to third directions may be measured by a micrometer measurement method. The micrometer measurement method may be performed by setting the zero point with a micrometer with Repeatability and Reproducibility (Gage R&R) and inserting the coil component 1000 according to the present embodiment between the tips of the micrometer and by turning the measuring lever of the micrometer. On the other hand, in measuring the length of the coil component 1000 by the micrometer measurement method, the length of the coil component 1000 may refer to a value measured once or may refer to an arithmetic average of values measured a plurality of times.

The body 100 may include a resin and a magnetic material. In detail, the body 100 may be formed by stacking one or more magnetic composite sheets in which a magnetic material is dispersed in a resin. The magnetic material may be ferrite or metallic magnetic powder. The ferrite may be at least one of, for example, spinel ferrites such as Mg—Zn, Mn—Zn, Mn—Mg, Cu—Zn, Mg—Mn—Sr, Ni—Zn, Ba—Zn, Ba—Mg, etc., hexagonal ferrites such as Ba—Ni, Ba—Co, Ba—Ni—Co, etc., Y-type garnet ferrites, and Li-type ferrites. The metal magnetic powder may include at least one selected from the group consisting of iron (Fe), silicon (Si), chromium (Cr), cobalt (Co), molybdenum (Mo), aluminum (Al), niobium (Nb), copper (Cu), and nickel (Ni). For example, the metal magnetic powder may be at least one of pure iron powder, Fe—Si alloy powder, Fe—Si—Al alloy powder, Fe—Ni alloy powder, Fe—Ni—Mo alloy powder, Fe—Ni—Mo—Cu alloy powder, Fe—Co alloy powder Alloy powder, Fe—Ni—Co alloy powder, Fe—Cr alloy powder, Fe—Cr—Si alloy powder, Fe—Si—Cu—Nb alloy powder, Fe—Ni—Cr alloy powder, and Fe—Cr—Al alloy powder. The magnetic metal powder may be amorphous or crystalline. For example, the magnetic metal powder may be Fe—Si—B—Cr-based amorphous alloy powder, but is not necessarily limited thereto. Each of the ferrite and magnetic metal powder may have an average diameter of about 0.1 μm to about 30 μm, but the present disclosure is not limited thereto. The body 100 may include two or more types of magnetic materials dispersed in resin. In this case, when the magnetic materials are of different types, it means that the magnetic materials dispersed in the resin are distinguished from each other by one of average diameter, composition, crystallinity, and shape. On the other hand, hereinafter, description will be made on the premise that the magnetic material is a metal magnetic powder, but the scope of the present disclosure does not extend only to the body 100 having a structure in which the metal magnetic powder is dispersed in a resin. The resin may include epoxy, polyimide, liquid crystal polymer, etc. alone or in combination, but is not limited thereto.

Further, the body 100 may include a core 110 penetrating the support member 200 and the coils 311 and 312 to be described later. The core 110 may be formed by filling a through-hole penetrating the center of the first and second coils 311 and 312 and the center of the support member 200 with a magnetic composite sheet containing a magnetic material.

The support member 200 is disposed inside of the body 100 and may support the coil 300. During a trimming process for forming the core 110, a central portion of the support member 200 may be removed to form a through-hole. The support member 200 may be trimmed according to the shape of the pads 341 and 342 to be described later to have a shape corresponding to the pads 341 and 342.

The support member 200 may have one surface S1 facing the sixth surface 106 of the body 100 and the other surface S2 facing the fifth surface 105 of the body 100.

The support member 200 is formed of an insulating material including a thermosetting insulating resin such as epoxy resin, a thermoplastic insulating resin such as polyimide, or a photosensitive insulating resin, or may be formed insulating material impregnated with a reinforcing material such as glass fiber or inorganic filler in the insulating resin. For example, the support member 200 may be formed of an insulating material such as prepreg, Ajinomoto Build-up Film (ABF), FR4, Bismaleimide Triazine (BT) resin, Photo Imageable Dielectric (PID), etc., but is not limited thereto. The example of the inorganic filler may include at least one selected from the group consisting of silica (silicon dioxide, SiO₂), alumina (aluminum oxide, Al₂O₃), silicon carbide (SiC), barium sulfate (BaSO₄), talc, mud, mica powder, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃) and calcium zirconate (CaZrO₃). When the support member 200 is formed of an insulating material including a reinforcing material, the support member 200 may provide superior rigidity. When the support member 200 is formed of an insulating material that does not contain glass fibers, it may be advantageous to reduce the thickness of the coil component 1000 according to the present embodiment. In addition, the volume occupied by the coils 311 and 312 and/or the magnetic metal powder may be increased based on the body 100 having the same size, so that component characteristics may be improved. When the support member 200 is formed of an insulating material including a photosensitive insulating resin, the number of processes for forming the coils 311 and 312 is reduced, which is advantageous in reducing production costs, and the conductive vias 320 may be formed minutely. The thickness of the support member 200 may be, for example, 10 μm or more and 50 μm or less, but is not limited thereto.

The first coil 311 is disposed on one surface S1 of the support member 200, and the second coil 312 is disposed on the other surface S2 of the support member 200. Each of the first coil 311 and the second coil 312 may have a planar spiral shape in which at least one turn is formed around the core 110 as an axis. Accordingly, the coils 311 and 312 of the coil component according to an embodiment of the present disclosure may include a straight portion and a curved portion. In detail, referring to FIG. 1, it can be seen that the body 100 has a straight portion in the first direction (X-direction) and has a curved portion in the second direction (Y-direction) of the body 100, but the present disclosure is not limited thereto. For example, the body 100 may have a curved portion in the first direction (X-direction) and a straight portion in the second direction (Y-direction).

The first coil 311 and the second coil 312 have side surfaces. In detail, the first coil 311 may have one side facing the outer turn and the other side facing the core. Similarly, the second coil 312 may have one side facing the outer turn and the other side facing the core.

The first and second coils 311 and 312 may respectively have substantially the same line width. In this case, the same line width indicates that the distances between one side and the other side of the respective first and second coils 311 and 312 are substantially the same. The line width of the first coil 311 and the line width of the second coil 312 may be the same, but are not necessarily limited thereto.

As will be described later, the other end of the

first coil 311 is connected to the first external electrode 400 and the other end of the second coil 312 is connected to the second external electrode 500. The other end of the first coil 311 may be the first lead-out portion 331, and the other end of the second coil 312 may be the second lead-out portion 332. Accordingly, the first and second lead-out portions 331 and 332 are connected to the first and second external electrodes 400 and 500, respectively.

The first pad 341 is disposed on one surface S1 of the support member 200 and is connected to one end of the first coil 311. In detail, the first pad 341 is formed on the innermost turn of the first coil 311. The second pad 342 is disposed on the other surface S2 of the support member 200 and is connected to one end of the second coil 312. In detail, the second pad 342 is formed on the innermost turn of the second coil 312. The first and second pads 341 and 342 are connected to a plurality of conductive vias 320 to be described later.

In the case of the coil component 1000 according to the first embodiment, the first and second pads 341 and 342 are positioned on straight portions of the coils 311 and 312. Also, the first and second pads 341 and 342 may be formed to be substantially parallel to a direction in which the coils 311 and 312 are wound. However, the present disclosure is not limited thereto, and as in the second embodiment to be described below, the first and second pads 341 and 342 may be located on curved portions of the coils 311 and 312, and as in the third embodiment, the first and second pads 341 and 342 may be formed to form a predetermined angle θ from the direction in which the coils 311 and 312 are wound.

The first pad 341 may have a first side facing the adjacent outer turn of the first coil 311 and a second side facing the core. Similarly, the second pad 342 may have a first side facing the adjacent outer turn of the second coil 312 and a second side facing the core. A first side of the first pad 341 may be connected to one side of the first coil 311, and a second side of the second pad 342 may be connected to the other side of the second coil 312.

The first and second pads 341 and 342 may respectively be wider than the line width Wc of the first and second coils 311 and 312. For example, in the case of the coil component according to the present embodiment, the width Wp of the pads 341 and 342 is increased, and therefore, the connectivity of the coils 311 and 312 may be further improved. In detail, referring to FIG. 4, the distance between the first side and the second side of the first pad 341 may be greater than the line width of the first coil 311. Similarly, the distance between the first side and the second side of the second pad 342 may be greater than the line width of the second coil 312.

The width Wp of the first and second pads 341 and 342 may be obtained by measuring the distance between the first and second sides of the first and second pads 341 and 342, respectively. In the case of the coil component according to the first embodiment, the first and second pads 341 and 342 are positioned on straight portions of the coils 311 and 312 in the first direction (X-direction). Therefore, a cross-sectional sample in the second direction (Y-direction) and third direction (Z-direction), passing through the center of the first pad 341 or the second pad 342, is taken, and a distance between the first side and the second side of the pads 341 and 342 may be obtained.

Similarly, the line width Wc of the first and second coils 311 and 312 may be obtained by measuring the distance between one side and the other side of the first and second coils 311 and 312, respectively. In the case of the coil component according to the first embodiment, the first and second coils 311 and 312 have straight portions in the first direction (X-direction). Therefore, the distance between one side and the other side of the coils 311 and 312 may be obtained by taking a cross-sectional sample in the second direction (Y-direction) and the third direction (Z-direction), penetrating the straight line.

Referring to FIG. 4, a first side of the first pad 341 may form a coplanar surface with one side surface of the first coil 311. The second side of the first pad 341 may protrude from the other side of the first coil 311 toward the core. This may be because the width Wp of the first pad 341 is wider than the line width Wc of the first coil 311. The same description may be applied to the second pad 342 as well. However, the present disclosure is not necessarily limited thereto, and like a modification to be described later, the first side of the first pad 341 may protrude from one side of the first coil 311 toward an adjacent outer turn of the first coil 311, and the second side of the first pad 341 may form a coplanar surface with the other side surface of the first coil 311. However, the present disclosure is not limited thereto, and both the first side and the second side of the first pad 341 may not form a coplanar surface with one side surface and the other side surface of the first coil 311, respectively.

To implement a thin-film power inductor that satisfies high current characteristics, there is a method of increasing the diameter of vias connecting upper and lower coils. However, when the via diameter is widened, defects such as seam voids may occur during via plating depending on the via hole processing diameter, depth, and shape. Therefore, in the embodiment according to the present disclosure, a structure in which the direct current resistance (Rdc) may be reduced while maintaining the diameter of the via at a certain level is newly proposed.

The conductive via 320 connects the first and second pads 341 and 342 and is provided in plurality in the present embodiment. The first and second coils 311 and 312 are connected to each other by first and second pads 341 and 342 and a plurality of conductive vias 320, and to this end, the conductive via 320 may pass through the support member 200.

As the first and second coils 311 and 312 are connected through the plurality of conductive vias 320, connectivity of the coil 300 may be improved in structural and electrical aspects. In detail, in this embodiment, as three or more conductive vias 320 are formed, the DC resistance (Rdc) of the coil component 1000 may be further reduced. In addition, since DC resistance (Rdc) may be reduced while maintaining the diameter of the conductive via 320 at a certain level, a seam void during via plating may be prevented.

Referring to FIG. 2, a method of connecting the first and second pads 341 and 342 and the plurality of conductive vias 320 will be described in detail. The plurality of conductive vias 320 may pass through the support member 200, so that one surface may be connected to the first pad 341 and the other surface may be connected to the second pad 342. The plurality of conductive vias 320 may connect the innermost turn of the first coil 311 and the innermost turn of the second coil 312 through the first and second pads 341 and 342.

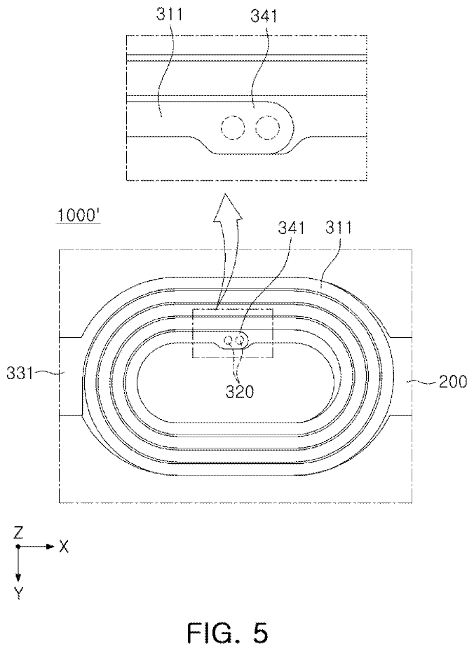

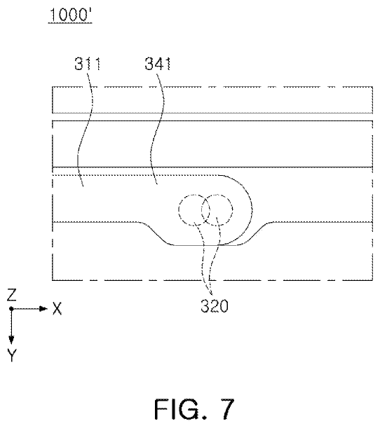

The coil component 1000 according to the first embodiment may include three or more conductive vias. In this embodiment, three conductive vias 320 are provided, and four or more conductive vias 320 may be included if necessary to further improve the connectivity of the coil 300. However, the present disclosure is not limited thereto, and two conductive vias 320 may be included as in the modified examples of FIGS. 5 and 7.

Referring to FIG. 4, the arrangement of the plurality of conductive vias 320 will be described.

The plurality of conductive vias 320 are arranged in a direction substantially parallel to the extending direction of the first coil 311.

The plurality of conductive vias 320 may be spaced apart from each other so as not to contact each other when the plurality of conductive vias 320 pass through the support member 200. The plurality of conductive vias 320 may be disposed at regular intervals. In detail, when the distance between the centers of the conductive vias 320 adjacent to each other in the plurality of conductive vias 320 is referred to as the pitch p, the pitch p may be greater than or equal to the diameter d of the conductive via 320. The diameter (d) and center of each conductive via 320 may be obtained by extracting the outline of the conductive via 320 from a plan view viewed from one direction (e.g., Z-direction). When the planar shape of the conductive via 320 is not perfectly circular, the diameter d may refer to a diameter equivalent to a circle.

The pitch p may be less than or equal to 2.25 times the diameter d of the conductive via 320.

The pitch p may be 60 μm or more and 135 μm or less. Also, the pitch p may be 60 μm or more and less than 160 μm.

The size of the pitch p of the conductive vias 320. will be described later with reference to Tables 1 and 2.

The pitch (p) may be measured in the following manner. First, a cross-sectional sample in a first direction (X-direction) and a second direction (Y-direction), penetrating the support member 200, is taken. Next, the pitch (p) value may be obtained by measuring the distance between the center of an arbitrary conductive via penetrating the support member 200 and the center of another conductive via adjacent thereto.

The diameter (d) of the conductive via may also be obtained by taking the same cross-sectional sample as above and measuring the diameter of an arbitrary conductive via.

As described above, in the case of the coil component according to the first embodiment, the first and second pads 341 and 342 may be located on straight portions of the coils 311 and 312, and the winding direction of the coils 311 and 312 may be substantially parallel to each other. Accordingly, in the case of the coil component according to the first embodiment, the plurality of conductive vias 320 may be arranged in one direction. In detail, the plurality of conductive vias 320 may be arranged in an extending direction of the first coil 311. For example, in the case of the coil component according to the first embodiment, the plurality of conductive vias 320 may be arranged in a direction parallel to the extending direction of the straight portions of the coils 311 and 312. However, the present disclosure is not limited thereto, and like a third embodiment to be described later, the plurality of conductive vias 320 may be arranged in a direction not parallel to the extending direction of the first coil 311.

The plurality of conductive vias 320 may be arranged in a linear direction. For example, the plurality of conductive vias 320 may be arranged along one straight line. Referring to FIGS. 4 to 9, it can be seen that the plurality of conductive vias 320 are arranged in the first direction (X-direction) of the body 100. However, the present disclosure is not limited thereto, and like the second embodiment to be described below, the plurality of conductive vias 320 may be arranged along a curve.

FIG. 5 is a view illustrating a modified example of the coil component according to the first embodiment. Referring to FIG. 5, the coil component includes two conductive vias 320.

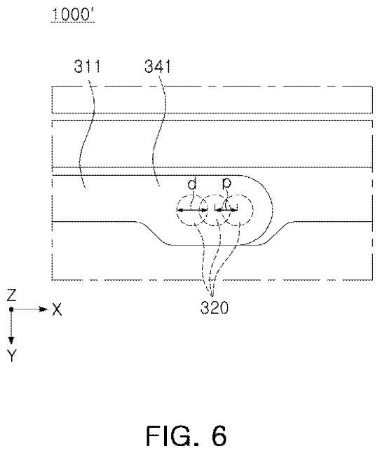

FIGS. 6 and 7 are views illustrating another modified example of the coil component according e first embodiment. Referring to FIGS. 6 and 7, at least two conductive vias 320 among the plurality of conductive vias 320 may form an overlapping structure in which the distance p between centers is less than the diameter d. In this case of forming an overlapping structure, the plurality of conductive vias 320 may be merged with each other to form an integral structure. The diameter d of each of the conductive vias 320 may be obtained by extracting the outline of the conductive vias 320 in a plan view viewed from one direction (e.g., the Z-direction of FIGS. 6 and 7). In this case, for the region where the conductive vias 320 overlap each other, the overall outline of the conductive via 320 may be obtained by extrapolating the outline of the non-overlapping region.

The distance p between the centers of the at least two conductive vias 320 may be greater than or equal to half of the diameter d.

In the at least two conductive vias 320, the distance p may be greater than or equal to 30 μm and less than 60 μm.

The present inventors simulated the performance of the coil components by Examples and Comparative Examples, and the results are illustrated in Tables 1 to 3 below. The size of the coil component is 2012 size, for example, the length in the first direction is 2.0 mm, the length in the second direction is 1.2 mm, and the length in the third direction is 0.8 mm.

Tables 1 and 2 illustrate the results of measuring the characteristics of the coil component by changing the distance p between the centers of the conductive vias while maintaining the diameter d of the conductive vias at 60 μm. As for the characteristics of the coil component, inductance characteristics (Ls), direct current resistance characteristics (Rdc), and saturation current characteristics (Isat) were measured. In the example of Table 1, the structure illustrated in FIGS. 4 and 6, for example, the coil component includes three conductive vias. The example of Table 2 has the structure illustrated in FIGS. 5 and 7, for example, the coil component includes two conductive vias. In the comparative example, when the distance p between the centers of the conductive vias is 0, for example, the coil component includes one conductive via. Further, when the distance p between the centers of the conductive vias is less than the diameter d of 60 μm of the conductive vias, the plurality of conductive vias form an overlapping structure. The cylinder model in the table below illustrates the theoretical resistance value of the cylinder-shaped conductive via itself.

TABLE 1

| Distance [μm] | Cylinder | Chip | R_{dc} | | Ls | |
|---|---|---|---|---|---|---|
| between via | Model | R_{dc} | Reduction | Ls | Reduction | Isat |
| centers | [mΩ] | [mΩ] | Ratio [%] | [μH] | Ratio [%] | [A] |
| 0 | 0.393 | 24.72 | — | 0.467 | — | 5.84 |
| 30 | 0.159 | 24.51 | 0.8 | 0.466 | 0.21 | 5.84 |
| 45 | 0.151 | 24.31 | 1.6 | 0.466 | 0.21 | 5.84 |
| 60 | 0.131 | 24.27 | 1.8 | 0.466 | 0.21 | 5.85 |
| 90 | 0.131 | 24.22 | 2.0 | 0.465 | 0.49 | 5.86 |
| 110 | 0.131 | 24.19 | 2.1 | 0.465 | 0.43 | 5.86 |
| 135 | 0.131 | 24.16 | 2.3 | 0.465 | 0.43 | 5.87 |
| 160 | 0.131 | 24.12 | 2.4 | 0.462 | 1.07 | 5.87 |
| 305 | 0.131 | 23.96 | 3.1 | 0.456 | 2.36 | 5.89 |

TABLE 2

| Distance [μm] | Cylinder | Chip | R_{dc} | | Ls | |
|---|---|---|---|---|---|---|
| between via | Model | R_{dc} | Reduction | Ls | Reduction | Isat |
| centers | [mΩ] | [mΩ] | Ratio [%] | [μH] | Ratio [%] | [A] |
| 0 | 0.393 | 24.72 | — | 0.467 | — | 5.84 |
| 30 | 0.226 | 24.61 | 0.4 | 0.466 | 0.21 | 5.84 |
| 60 | 0.196 | 24.42 | 1.2 | 0.466 | 0.21 | 5.84 |
| 90 | 0.196 | 24.37 | 1.4 | 0.465 | 0.43 | 5.84 |
| 110 | 0.196 | 24.34 | 1.5 | 0.465 | 0.43 | 5.86 |
| 135 | 0.196 | 24.32 | 1.6 | 0.465 | 0.43 | 5.87 |
| 160 | 0.196 | 24.30 | 1.7 | 0.465 | 0.43 | 5.86 |

Referring to Tables 1 and 2, when the centers of the conductive vias are spaced apart from each other, the ratio of the obtained DC resistance (Rdc) reduction to the reduction in inductance (Ls) is high, so that a higher connection resistance reduction effect may be obtained. In detail, when the centers of the conductive vias are spaced apart from each other, a theoretical connection resistance reduction effect may be obtained by an increase in the cross-sectional area of the conductive vias.

In detail, when the distance (pitch, p) between via centers is less than or equal to 2.25 times the diameter (d) of the via, the ratio of DC resistance (Rdc) reduction to inductance (Ls) reduction is high, and thus, a relatively higher connection resistance reduction effect may be obtained. When the diameter (d) of the conductive via is 60 μm and when the pitch (p) is 60 μm or more and 135 μm or less, or 60 μm or more and less than 160 μm, a high connection resistance reduction effect may be obtained.

Table 3 illustrates the results of measuring the characteristics of the coil component by changing the diameter (d) and number of conductive vias while maintaining the thickness of the conductive vias at 60 μm. When the coil component has two or more conductive vias, the distance p between the centers of the conductive vias was maintained at 100 μm. As for the characteristics of the coil component, the DC resistance characteristics (Rdc) were measured, and the theoretical values when the conductive vias were cylinder-shaped were also provided.

TABLE 3

| R_{dc} [mΩ] | Theoretical value | | | | | |
|---|---|---|---|---|---|---|
| Comparison Table | for Cylinder shape | | | R_{dc} in real chip | | |
| Change only in | 60 | 80 | 100 | 60 | 80 | 100 |
| diameter [μm] of | 0.393 | 0.221 | 0.141 | 24.72 | 24.47 | 24.34 |
| single via | | | | | | |
| Change in number | 1 | 2 | 3 | 1 | 2 | 3 |
| of vias | 0.393 | 0.196 | 0.131 | 24.72 | 24.30 | 24.2 |

Referring to Table 3, by increasing the number of conductive vias, a reduction in resistance, equal to or greater than an increase in the diameter of the conductive vias (or the cross-sectional area of the conductive vias) may be obtained. For example, even if the via diameter (d) is not designed to be relatively large, the DC resistance (Rdc) may be reduced, and therefore, seam void defects may be prevented.

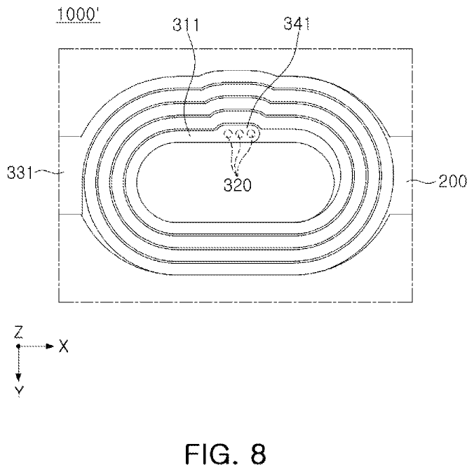

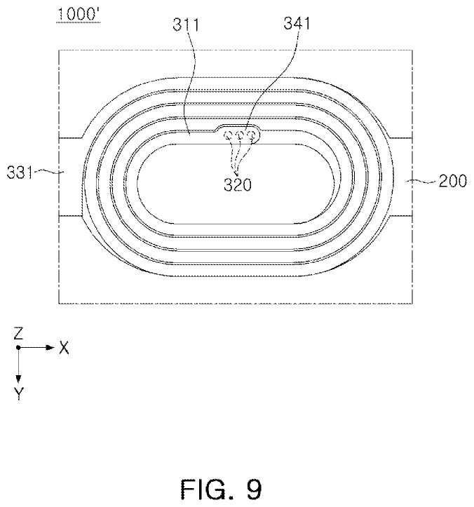

FIGS. 8 and 9 are views illustrating another modified example of the coil component according to the first embodiment. When the plurality of conductive vias 320 are used, the size of the core 110 may be reduced, and thus, there is a possibility that the magnetic characteristics of the coil component 1000 are degraded. In the following modification, the deterioration in magnetic properties was significantly reduced by the appropriate arrangement of the pads 341 and 342.

Referring to FIGS. 8 and 9, the second side of the first pad 341 may form a coplanar surface with the other side surface of the first coil 311. Since the second side of the first pad 341 is coplanar with the other side surface of the first coil 311, the size of the core 110 may be sufficiently secured.

The first side of the first pad 341 protrudes from one side of the first coil 311 toward an adjacent outer turn of the first coil 311. An outer turn adjacent to the first pad 341 may have a concave portion accommodating at least a portion of the first pad 341.

Referring to FIG. 9, the outer turn of the first coil 311 adjacent to the first pad 341 has a concave portion, and may thus include a section having a smaller line width than other turns. However, the present disclosure is not limited thereto, and the outer turns of the first coil 311 adjacent to the first pad 341 may have the same line width as other turns even if they have concave portions. Referring to FIG. 8, outer turns of the first coil 311 based on the first pad 341 may have a protruding shape to follow the shape of the first pad 341.

The same description may also be applied to the second pad 342, and detailed descriptions are omitted hereafter since they are redundant.

The first and second coils 311 and 312 may include at least one conductive layer. In detail, the first and second coils 311 and 312 may be formed by a plating process, and in this case, may include a seed layer and an electrolytic plating layer. In this case, the electrolytic plating layer may have a single-layer structure or a multi-layer structure. The electrolytic plating layer of the multi-layer structure may be formed in a conformal film structure in which another electrolytic plating layer is formed along the surface of one electrolytic plating layer, and may also be formed in a shape in which another electrolytic plating layer is stacked on only one surface of one electrolytic plating layer. The seed layer may be formed by a vapor deposition method such as electroless plating or sputtering. The first and second coils 311 and 312 may be integrally formed with the seed layer so that a boundary may not be formed therebetween, but the present disclosure is not limited thereto. In addition, the respective electrolytic plating layers in the first and second coils 311 and 312 may be integrally formed so that a boundary may not be formed therebetween, the present disclosure is not limited thereto.

The conductive via 320 may include at least one conductive layer. For example, when the conductive via 320 is formed by electroplating, the conductive via 320 may include a seed layer formed on the inner wall of the via hole penetrating the support member 200, and an electrolytic plating layer filling the via hole where the seed layer is formed. The seed layer of the conductive via 320 is formed together with the seed layers of the coils 311 and 312 in the same process and formed integrally with each other, or a boundary may be formed between the seed layers of the coils 311 and 312 by being formed in a different process. The electrolytic plating layer of the conductive via 320 is formed together with the plating layers of the coils 311 and 312 in the same process and formed integrally with each other, or may be formed in a process different from the process of the plating layers of the coils 311 and 312, so that a boundary therebetween may be formed.

The first and second coils 311 and 312 and the conductive via 320 may be formed of a conductive material of copper (Cu), aluminum (Al), silver (Ag), tin (Sn), gold (Au), nickel (Ni), lead (Pb), titanium (Ti), chromium (Cr) or alloys thereof, etc., but are not limited thereto.

An insulating layer may be formed on the surfaces of the first and second coils 311 and 312. The insulating layer may integrally cover the first and second coils 311 and 312 and the support member 200. In detail, the insulating layer may be disposed between the first and second coils 311 and 312 and the body 100 and between the support member 200 and the body 100. The insulating layer may be formed along the surface of the support member 200 on which the first and second coils 311 and 312 are formed, but the present disclosure is not limited thereto. The insulating layer may fill a region such as between adjacent turns of the first and second coils 311 and 312. The insulating layer is for electrically separating the first and second coils 311 and 312 and the body 100, and may include a known insulating material such as parylene, but is not limited thereto. As another example, the insulating layer may include an insulating material such as an epoxy resin other than parylene. The insulating layer may be formed by vapor deposition, but is not limited thereto. As another example, the insulating layer may be formed by laminating and curing an insulating film for forming the insulating layer, on both sides of the support member 200 on which the first and second coils 311 and 312 are formed, and may also be formed by applying and curing an insulating paste for forming the insulating layer on both sides of the support member 200 on which the first and second coils 311 and 312 are formed. On the other hand, for the reasons described above, the insulating layer is a component that may be omitted in this embodiment. For example, if the body 100 has sufficient electrical resistance at the designed operating current and voltage of the coil component 1000, the insulating layer may be omitted in this embodiment.

The first and second external electrodes 400 and 500 are spaced apart from each other on the body 100 and connected to the other ends of the first and second coils 311 and 312, respectively. In detail, the first external electrode 400 is disposed on the first surface 101 of the body 100 and is connected to the first lead-out portion 331 exposed through the first surface 101 of the body 100. The second external electrode 500 may be disposed on the second surface 102 of the body 100 and connected to the second lead-out portion 332 exposed through the second surface 102 of the body 100. The first external electrode 400 may be disposed on the first surface 101 of the body 100 and may extend to at least portions of the third to sixth surfaces 103, 104, 105, and 106 of the body 100. The second external electrode 500 may be disposed on the second surface 102 of the body 100 and may extend to at least portions of the third to sixth surfaces 103, 104, 105, and 106 of the body 100. On the other hand, a structure in which the first and second external electrodes 400 and 500 respectively disposed on the first and second surfaces 101 and 102 of the body 100 are respectively extended only to the sixth surface 106 of the body 100 may be provided.

The external electrodes 400 and 500 may be formed by a vapor deposition method such as sputtering and/or a plating method, but are not limited thereto. The external electrodes 400 and 500 may be formed of a conductive material of copper (Cu), aluminum (Al), silver (Ag), tin (Sn), gold (Au), nickel (Ni), lead (Pb), chromium (Cr), titanium (Ti), alloys thereof, etc., but the present disclosure is not limited thereto. The external electrodes 400 and 500 may have a single-layer or multi-layer structure. For example, the external electrodes 400 and 500 may include a first conductive layer containing copper (Cu), a second conductive layer disposed on the first conductive layer and containing nickel (Ni), and a third conductive layer disposed on the second conductive layer and containing tin (Sn). At least one of the second conductive layer and the third conductive layer may be formed to cover the first conductive layer, but the scope of the present disclosure is not limited thereto. The first conductive layer may be a plating layer or a conductive resin layer formed by applying and curing a conductive resin containing a resin and conductive powder containing at least one of copper (Cu) and silver (Ag). The second and third conductive layers may be plating layers, but the scope of the present disclosure is not limited thereto.

The coil component 1000 according to the present embodiment may further include external insulating layers disposed on the third to sixth surfaces 103, 104, 105, and 106 of the body 100. The external insulating layer may be disposed in an area other than the area where the external electrodes 400 and 500 are disposed. At least some of the external insulating layers respectively disposed on the third to sixth surfaces 103, 104, 105, and 106 of the body 100 are formed in the same process and formed integrally without a boundary therebetween, but the scope of the present disclosure is not limited thereto. The external insulating layer may be formed by forming an insulating material for forming the external insulating layer using a printing method, vapor deposition, spray coating method, film lamination method, or the like, but is not limited thereto. The external insulating layer may include a thermoplastic resin such as polystyrene, vinyl acetate, polyester, polyethylene, polypropylene, polyamide, rubber, acrylic, etc., a thermosetting resin such as phenol-based, epoxy-based, urethane-based, melamine-based, and alkyd-based resin, a photosensitive resin, parylene, SiOx or SiNx. The external insulating layer may further include an insulating filler such as an inorganic filler, but is not limited thereto.

### Second Embodiment

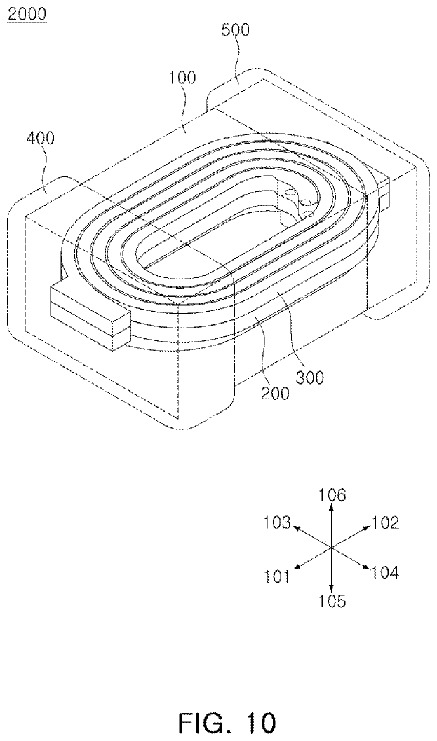

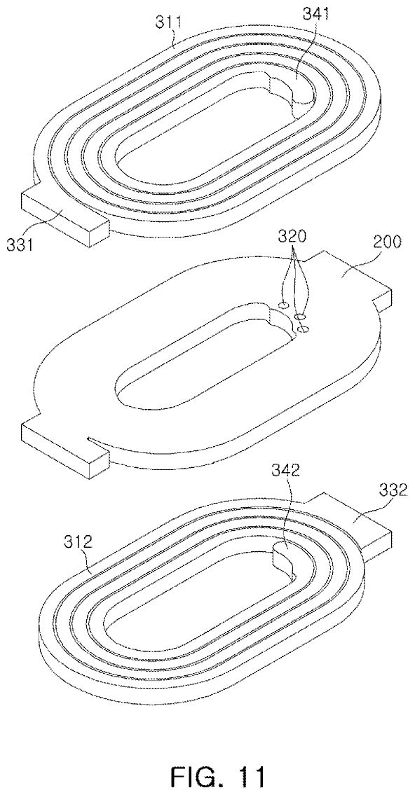

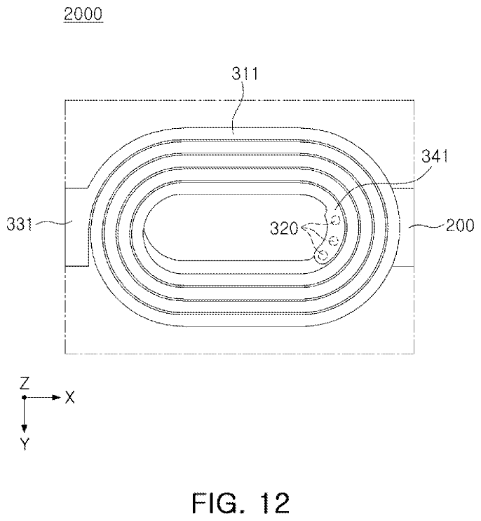

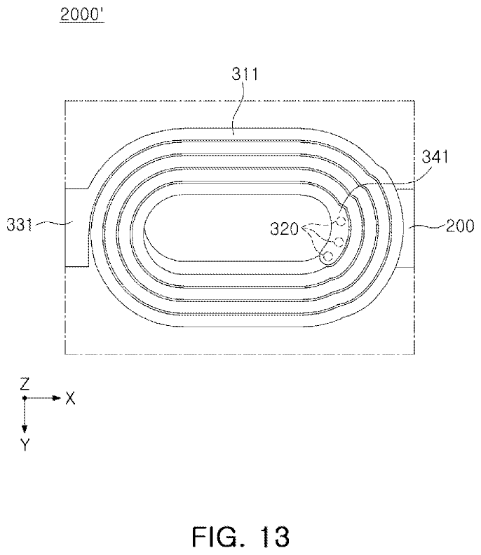

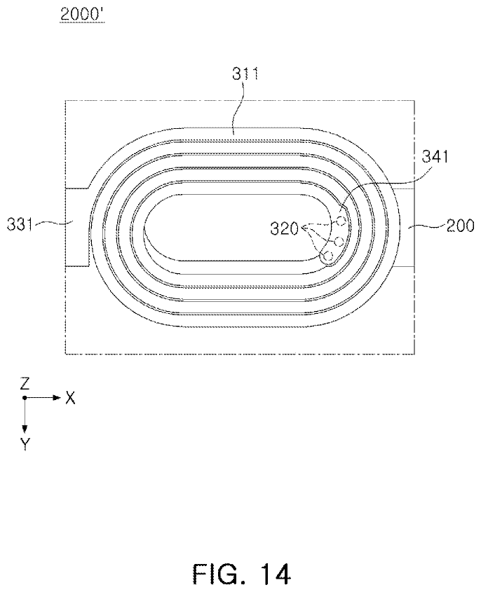

FIG. 10 is a perspective view schematically illustrating a coil component according to a second embodiment. FIG. 11 is an exploded view illustrating some components of FIG. 10, and is an assembly view illustrating connection relationships between components. FIG. 12 is a plan view of the coil component of FIG. 10, viewed from the top. FIGS. 13 and 14 are plan views of a coil component viewed from above as a modified example of the second embodiment.

In the case of a coil component 2000 according to the second embodiment, the first and second pads 341 and 342 are located on curved portions of the coils 311 and 312. Accordingly, the plurality of conductive vias 320 may be arranged along a curve.

For example, as described above, since the coils 311 and 312 may have a curved portion in the second direction (Y-direction) of the body 100, the pads 341 and 342 may be disposed to be biased toward either one of the first surface 101 (first side) or the second surface 102 (second side). In detail, the first pad 341 may be disposed closer to the second surface 102 (second side) than to the first surface 101 (first side), and the second pad 342 may be disposed closer to the first surface 101 (first side) than to the second surface 102 (second side).

Referring to FIGS. 13 and 14, a first side of the first pad 341 may have a form protruding from the side of the first coil 311 toward an adjacent outer turn of the first coil 311. Also, the outer turn of the first coil 311 adjacent to the first pad 341 may have a concave portion accommodating at least a portion of the first pad 341.

The description of the first embodiment may be applied as it is to the rest of the configuration of this embodiment, and detailed descriptions are redundant and will be omitted below.

### Third Embodiment

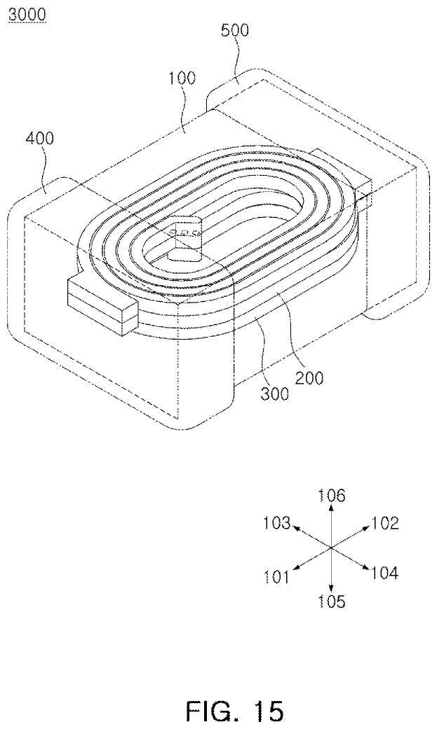

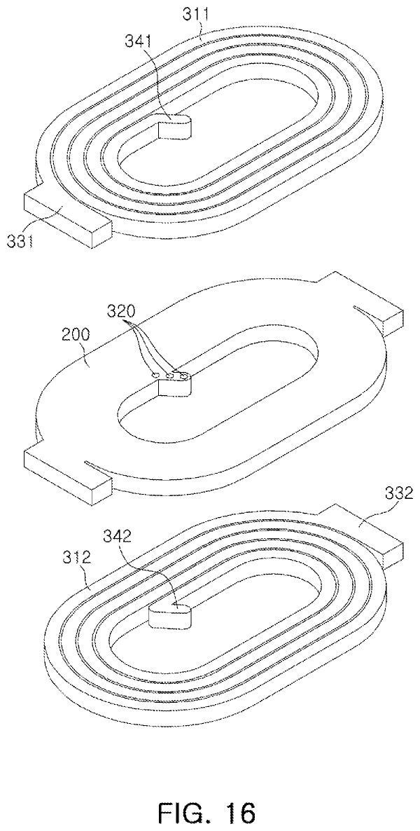

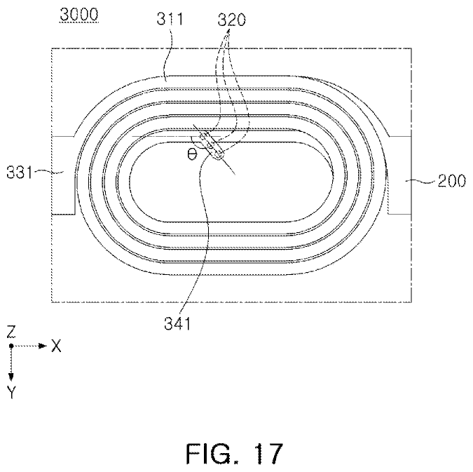

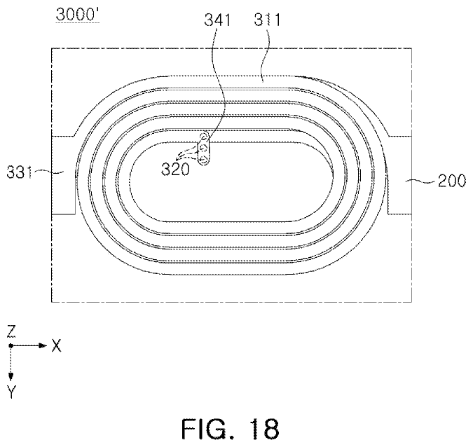

FIG. 15 is a perspective view schematically illustrating a coil component according to a third embodiment. FIG. 16 is an exploded view illustrating some components of FIG. 15, and is an assembly view illustrating connection relationships between components. FIG. 17 is a plan view of the coil component of FIG. 16 viewed from the top. FIG. 18 is a plan view of a coil component viewed from above as a modified example of the third embodiment.

In the case of a coil component 3000 according to the third embodiment, the first and second pads 341 and 342 are located on the straight portions of the coils 311 and 312, but the arrangement of the pads 341 and 342 and the arrangement of the conductive vias 320 are different from those of the first embodiment. Hereinafter, differences from the first embodiment will be mainly described.

Referring to FIGS. 17 to 18, the first and second pads 341 and 342 may be formed to form a predetermined angle θ in the direction in which the coils 311 and 312 are wound. The predetermined angle θ may have an angle greater than 0 degrees and less than 180 degrees.

The plurality of conductive vias 320 are arranged in a direction not parallel to the extending direction of the first coil 311. In detail, the plurality of conductive vias 320 may be arranged in an inclined direction with respect to the extending direction of the first coil 311. An angle between the direction in which the plurality of conductive vias 320 are arranged and the extending direction of the first coil 311 may also be the same as the predetermined angle θ. Accordingly, the angle between the direction in which the plurality of conductive vias 320 are arranged and the extending direction of the first coil 311 may have an angle greater than 0 degrees and less than 180 degrees.

Referring to FIG. 18, the plurality of conductive vias 320 are arranged in a direction perpendicular to the extending direction of the first coil 311. In this case, since the filling rate of the magnetic material in the center of the core 110 may be significantly increased, it may be advantageous for the magnetic properties of the coil component.

Table 4 illustrates the results of measuring the

characteristics of the coil component according to the disposition direction of the conductive vias while maintaining the diameter (d) of the conductive vias at 60 μm. As for the characteristics of the coil components, inductance characteristics (Ls), DC resistance characteristics (Rdc), and DC bias [A] were measured. In Example 1, as illustrated in FIG. 4, two conductive vias 320 are arranged in the extending direction of the first coil 311. In Example 2, as illustrated in FIG. 18, three conductive vias 320 are arranged in a direction perpendicular to the extending direction of the first coil 311. A comparative example is a case including a single conductive via.

TABLE 4

| | Ref | Example 1 | | | Example 2 | | | |
|---|---|---|---|---|---|---|---|---|
| Distance [μm] | — | 50 | 75 | 100 | 50 | 75 | 100 | 245 |
| between via | | | | | | | | |
| centers | | | | | | | | |
| Ls [μH] | 0.467 | 0.465 | 0.465 | 0.465 | 0.466 | 0.466 | 0.466 | 0.463 |
| Ls | — | 0.4 | 0.5 | 0.6 | 0.2 | 0.3 | 0.4 | 0.9 |
| Reduction | | | | | | | | |
| Ratio [%] | | | | | | | | |
| R_{dc} [mΩ] | 24.72 | 24.34 | 24.32 | 24.30 | 24.41 | 24.42 | 24.42 | 24.45 |
| R_{dc} | — | 1.6 | 1.6 | 1.7 | 1.3 | 1.2 | 1.2 | 1.1 |
| Reduction | | | | | | | | |
| Ratio [%] | | | | | | | | |
| DC bias [A] | 5.84 | 5.86 | 5.87 | 5.86 | 5.87 | 5.86 | 5.88 | 5.86 |

The description of the first embodiment may be applied as it is to the rest of the configuration of this embodiment, and detailed descriptions are redundant and will be omitted below.

As set forth above, according to an embodiment, a coil component having excellent characteristics may be implemented by reducing resistance of a via connection without defects.

While example embodiments have been illustrated and described above, it will be apparent to those skilled in the art that modifications and variations could be made without departing from the scope of the present disclosure as defined by the appended claims.

What is claimed is:

1. A coil component comprising:
a body;
a support member disposed within the body;
a first coil disposed on one surface of the support member;
a second coil disposed on the other surface of the support member;
a first pad connected to one end of the first coil;
a second pad connected to one end of the second coil;
a plurality of conductive vias connecting the first pad and the second pad;
a first external electrode disposed on the body and connected to the other end of the first coil; and
a second external electrode disposed on the body and connected to the other end of the second coil.

2. The coil component of claim 1, wherein the plurality of conductive vias are spaced apart from each other without contacting each other.

3. The coil component of claim 1, wherein the plurality of conductive vias are arranged in one direction.

4. The coil component of claim 3, wherein, when a distance between centers of adjacent conductive vias in the plurality of conductive vias is defined as a pitch, the pitch is greater than or equal to a diameter of the conductive vias.

5. The coil component of claim 4, wherein the pitch is less than or equal to 2.25 times the diameter.

6. The coil component of claim 4, wherein the pitch is 60 μm or more and 135 μm or less.

7. The coil component of claim 4, wherein the pitch is 60 μm or more and less than 160 μm.

8. The coil component of claim 3, wherein the plurality of conductive vias are arranged in an extending direction of the first coil.

9. The coil component of claim 3, wherein the plurality of conductive vias have centers aligned in a straight line.

10. The coil component of claim 1, wherein in the first pad, a first side surface facing an adjacent outer turn of the first coil protrudes from a side surface of the first coil connected to the first side surface toward the adjacent outer turn of the first coil.

11. The coil component of claim 10, wherein in the first pad, a second side surface facing the first side surface is coplanar with the side surface of the first coil connected to the second side surface.

12. The coil component of claim 10, wherein an outer turn, adjacent to the first pad in the first coil, has a concave portion accommodating at least a portion of the first pad.

13. The coil component of claim 1, wherein the body includes a first side surface and a second side surface opposing each other,
the other end of the first coil extends to the first side surface, and
the first pad is disposed closer to the second side surface than the first side surface.

14. The coil component of claim 13, wherein the plurality of vias are arranged along a curve.

15. The coil component of claim 1, wherein the plurality of conductive vias are provided in three or more.

16. The coil component of claim 1, wherein the first pad has a width wider than a line width of the first coil, and
the second pad has a width wider than a line width of the second coil.

17. A coil component comprising:
a body;
a support member disposed within the body;
a first coil disposed on one surface of the support member;
a second coil disposed on the other surface of the support member;
a first pad connected to one end of the first coil;
a second pad connected to one end of the second coil;
a plurality of conductive vias connecting the first pad and the second pad and arranged along a straight line;
a first external electrode disposed on the body and connected to the other end of the first coil; and
a second external electrode disposed on the body and connected to the other end of the second coil.

18. The coil component of claim 17, wherein the plurality of conductive vias are arranged in a direction, not parallel to an extending direction of the first coil.

19. The coil component of claim 18, wherein the plurality of conductive vias are arranged in a direction, perpendicular to the extending direction of the first coil.

20. The coil component of claim 18, wherein the plurality of conductive vias are arranged in a direction inclined with respect to the extending direction of the first coil.

21. The coil component of claim 17, wherein, when a distance between centers of adjacent conductive vias in the plurality of conductive vias is defined as a pitch, the pitch is greater than or equal to a diameter of the conductive vias.

22. The coil component of claim 21, wherein the pitch is less than or equal to 2.25 times the diameter.

23. The coil component of claim 22, wherein the pitch is 60 μm or more and 135 μm or less.

24. The coil component of claim 21, wherein the pitch is 60 μm or more and less than 160 μm.

25. A coil component comprising:
a body;
a support member disposed within the body;
a first coil disposed on one surface of the support member;
a second coil disposed on the other surface of the support member;
a first pad connected to one end of the first coil;
a second pad connected to one end of the second coil;
a plurality of conductive vias connecting the first pad and the second pad;
a first external electrode disposed on the body and connected to the other end of the first coil; and
a second external electrode disposed on the body and connected to the other end of the second coil,
wherein at least two of the plurality of conductive vias form an overlapping structure in which a distance between centers thereof is less than a diameter thereof.

26. The coil component of claim 25, wherein the at least two conductive vias have the distance greater than or equal to half the diameter.

27. The coil component of claim 25, wherein the at least two conductive vias have the distance greater than or equal to 30 μm and less than 60 μm.

28. A coil component comprising:
a first coil disposed on a first surface of a support member and wound around a core penetrating the support member;
a second coil disposed on a second surface of the support member and wound around the core, the second surface being opposite the first surface;
a first pad connected to a first end of the first coil adjacent the core;
a second pad connected to a first end adjacent of the second coil the core;
a plurality of conductive vias connecting the first pad and the second pad, and penetrating the support member,
wherein the first pad has a width greater than that of the first end of the first coil, and the second pad has a width greater than that of the first end of the second coil.

29. The coil component of claim 28, wherein the plurality of conductive vias are disposed in a straight line along a length of the first and second pads.

30. The coil component of claim 28, wherein each of the first and second coils comprises a plurality of turns, and the coil component further comprises:
a first external electrode connected to a second end of the first coil adjacent an outermost turn thereof; and
a second external electrode connected to a second end of the second coil adjacent an outermost turn thereof.

31. The coil component of claim 30, further comprising a body in which the first coil, the second coil and the support member are embedded,
wherein the first external electrode and the second external electrode are disposed on opposite surfaces of the body.

32. The coil component of claim 30, wherein the first and second pads have a length extending along a direction connecting the first and second external electrodes.

33. The coil component of claim 30, wherein the first and second pads have a length at an angle relative to a direction connecting the first and second external electrodes.

34. The coil component of claim 30, wherein the first and second pads are disposed along a curved portion of corresponding coil turns, and the plurality of conductive vias are disposed along a curve of the curved portion.

35. The coil component of claim 28, wherein the plurality of conductive vias do not overlap each other in a plane coplanar to a plane of the first or second surface of the support member.
